(19) United States
(12) Patent Application Publication
(10) Pub. No.: US 2004/0196184 A1
(43) Pub. Date: Oct. 7, 2004

(54) Method and apparatus for determining the position and orientation of an object using a doppler shift of electromagnetic signals

(76) Inventors: KEVIN HOLLANDER, PHOENIX, AZ (US); JOHN STANDEVEN, ROCK HILL, MO (US); JACK R. ENGSBERG, EUREKA, MO (US)

Correspondence Address: Kirill Y. Abramov, Sonnenschein Nath & Rosenthal, Wacker Drive Station, Sears Tower, P.O. Box #061080, Chicago, IL, 60606-1080, US

(21) Appl. No.: 10/408,484

(22) Filed: Apr. 7, 2003

(51) Int. Cl. G01S 3/52; G01S 5/02

(52) U.S. Cl. 342/418; 342/428

(57) ABSTRACT

A method and apparatus for determining the position and/or the orientation of a movable object using a Doppler shift of electromagnetic signals. The apparatus includes a transmitter for transmitting a periodic electromagnetic signal, a sensor mountable on the object for receiving the signal transmitted by the transmitter and a controller in communication with the transmitter and the sensor for determining the position and/or orientation of the sensor relative the transmitter.

### BACKGROUND OF THE INVENTION

The present invention relates generally to a motion capture apparatus, and more specifically to a method and apparatus for determining and tracking the position and orientation of a movable object using a Doppler shift of electromagnetic signals.

Motion capture is a method of measuring the position of a movable object over a period of time. Motion capture is frequently used to evaluate human and animal movements in the medical fields, sports analysis, special effects for movies and video games, and other applications. Conventional motion capture systems range from relatively primitive systems involving analysis of successive frames of photographic film, to more sophisticated systems using optical, magnetic, ultrasonic and radio frequency technology to track movement of an object. Conventional motion capture systems are subject to several limitations. Specifically, many conventional motion capture systems are unable to determine the position and orientation of objects with a high degree of accuracy, and others are unable to make measurements of many objects simultaneously. Still other conventional motion capture systems are capable of operating only over a short distance or in a limited area.

The present invention overcomes the limitations of the conventional motion capture systems by sensing the Doppler shift of an orbiting electromagnetic signal.

The Doppler shift is an apparent change in the frequency of a signal transmitted by a source due to the source's motion relative to the observer. An example of the Doppler shift is the change in pitch of a passing train whistle. As a moving train approaches a stationary observer, the frequency (i.e., pitch) of the whistle is higher than the whistle frequency of a stationary train. After the train passes, the frequency of the train whistle is lower than the whistle frequency of a stationary train.

The Doppler effect is not limited to sound and can be observed in other types of wave phenomenon. For example, electromagnetic (“EM”) signals emitted by a moving source, may also demonstrate a change or shift in frequency due to the Doppler effect. The Doppler effect depends on the proportion of source speed to signal speed. Because EM signals propagate at the speed of light, the proportion of source speed to signal speed is very low, producing a hard-to-detect Doppler effect.

An electromagnetic Doppler field is generated by a moving source transmitting an EM signal with a constant source frequency. For example, an antenna transmitting an EM signal while traveling in a circular path or orbit will create a Doppler field. A stationary receiving antenna positioned in the Doppler field will detect the Doppler shift of the signal transmitted by the orbiting antenna as it moves toward and away from the receiving antenna. The stationary receiving antenna detects an increase and decrease in the source frequency of the transmitted signal corresponding to the movement of the transmitting antenna in its orbit.

The amount of the Doppler shift in the source frequency of the transmitted signal is directly proportional to the ratio of the source speed to the signal speed. Because the signal speed of an EM signal is equal to the speed of light (i.e., approximately 3×10⁸ meters/second), the orbiting rate of the orbiting transmitting antenna must be high to produce a detectable Doppler shift at the receiving antenna.

A mechanical device can be used to create an antenna orbiting rate sufficiently high to cause a detectable Doppler shift in the base frequency of the transmitted signal.

### SUMMARY OF THE INVENTION

Briefly, the apparatus of this invention comprises a transmitter having a transmitter antenna for transmitting a periodic electromagnetic signal. Further, the apparatus includes a sensor mountable on the object for receiving the signal transmitted by the transmitter and a controller in communication with the transmitter and the sensor for determining the position of the sensor relative to the transmitter thereby determining the position of the object upon which said sensor is mounted relative to said transmitter.

In another aspect of the invention, a transmitter has an antenna array including a plurality of antennae. Each of the antennae transmits an electromagnetic signal having a periodic amplitude varying at a predetermined frequency equal to that of the signals transmitted by the other antennae within the array. The signal transmitted by each of the antennae is phase shifted relative to the signal transmitted by the adjacent antennae so the signals transmitted by the antenna array form a traveling composite electromagnetic signal.

In yet another aspect, the apparatus comprises a transmitter having a first transmitter antenna for transmitting a first periodic electromagnetic signal in a first plane and a second transmitter antenna for transmitting a second periodic electromagnetic signal in a second plane. Further, the apparatus includes a sensor mountable on the object for receiving the signals transmitted by the transmitter and a controller in communication with the transmitter and the sensor for determining the position and orientation of the sensor relative to the transmitter thereby determining the position and orientation of the object upon which said sensor is mounted relative to said transmitter.

In still another aspect, the method of this invention includes a method comprising the steps of transmitting a periodic electromagnetic signal, detecting the signal with a sensor mountable on the object, converting the signal into a Doppler shift zero crossing indicator and determining from the indicator the position and orientation of the sensor relative to the transmitter thereby determining the position of the object upon which the sensor is mounted relative to the transmitter.

Other aspects of the present invention will be in part apparent and in part pointed out hereinafter.

### BRIEF DESCRIPTION OF THE DRAWINGS

FIG. 1 is a schematic top plan of a first embodiment of apparatus of the present invention.

FIG. 2 is a graph of signal strength over time generated by the apparatus illustrated in FIG. 1.

FIG. 3 is a schematic perspective of the first embodiment of apparatus of the present invention.

FIG. 4 is a schematic perspective of a second embodiment of apparatus of the present invention.

FIG. 5 is a vector diagram for calculating a position and orientation of the sensor triad.

FIG. 6 is a schematic perspective of a third embodiment of apparatus of the present invention.

Corresponding reference characters indicate corresponding parts throughout the several views of the drawings.

### DETAILED DESCRIPTION OF THE PREFERRED EMBODIMENT

The present invention includes a virtual antenna. In its most fundamental sense, a virtual antenna may consist of two actual antennas transmitting an identical signal at different power levels. If properly phased, the composite signal produced by the antennas will appear to a distant observer to originate from a single virtual transmitting antenna located between the two actual antennas. The apparent location of the virtual antenna is at a position corresponding to the ratio of the power levels of the transmitted signals. Extending this concept to more actual transmitting antennas, it is possible to create a planar field of virtual antenna locations by the proper placement, power level adjustment and phasing of discrete actual antennas.

Using this concept, it is possible to simulate a circular orbit of a transmitting antenna. To accomplish this, a plurality of discrete actual antennas are arranged in a circular configuration and their power levels cyclically adjusted to simulate a single transmitting antenna orbiting in a circular path. The orbiting rate of a virtual orbiting antenna is not constrained by the inertia of a mechanical device, allowing for higher orbiting rates and consequently making the Doppler shift observed by the receiving antenna more pronounced.

FIG. 1 illustrates a motion capture apparatus, generally designated by 6, including a virtual antenna, generally designated by 8, having eight discrete transmitting antennae 10 arranged in a circular configuration having a radius a. The antennae 10 simultaneously transmit cyclic or periodic EM signals at different and varying power levels. A receiving antenna 12 for receiving the EM signal is located in a plane defined by the circular configuration of transmitting antennae 10. The distance d is the distance that the EM signal transmitted by each transmitting antenna 10 travels to reach the receiving antenna 12. Equation 1 defines the distance d between each transmitting antenna 10 and the receiving antenna 12.

dⱼ=\sqrt{l²−2·a·l·cos θⱼ+a²} (1)

The subscript j is the indexed position of each transmitting antenna 10 and j=0 to 7.

The signal received by the receiving antenna 12 from each transmitting antenna 10 is represented by Equation 2:

$${signal}_{i , j} := [ \frac{A}{2} + \frac{A}{2} \cdot cos [ 2 \cdot π \cdot {ω}_{d} \cdot ( {t}_{i} - \frac{{d}_{j}}{c} ) + {θ}_{j} ] ] \cdot cos [ 2 \cdot π \cdot {ω}_{rf} \cdot ( {t}_{i} - \frac{{d}_{j}}{c} ) ] \qquad ( 2 )$$

In Equation 2, i is the index of the time variable, j is the index of individual transmitting antennae, A is an arbitrary amplitude of the transmitted EM signal, d is the distance described by Equation 1, ω_{d} is the frequency of the signal amplitude cycling, c is the propagation velocity of the transmitted EM signal (i.e., approximately 3×10⁸ meters/second), t is the time variable, θ is the signal amplitude phase shift corresponding to the indexed angular position of each individual transmitting antenna 10, and ω_{rf} is the base frequency of the transmitted EM signal.

The first term of Equation 2 describes the peak amplitude of the signal transmitted by each of the transmitting antennae 10. The second cosine term of Equation 2 describes the phase shift of the signal transmitted by each of the transmitting antennae 10. The distance d represented by Equation 1 drives the delay for both terms of Equation 2. The presence of the distance d in Equation 2 accounts for the lag in time that occurs as the transmitted signal travels to the receiving antenna.

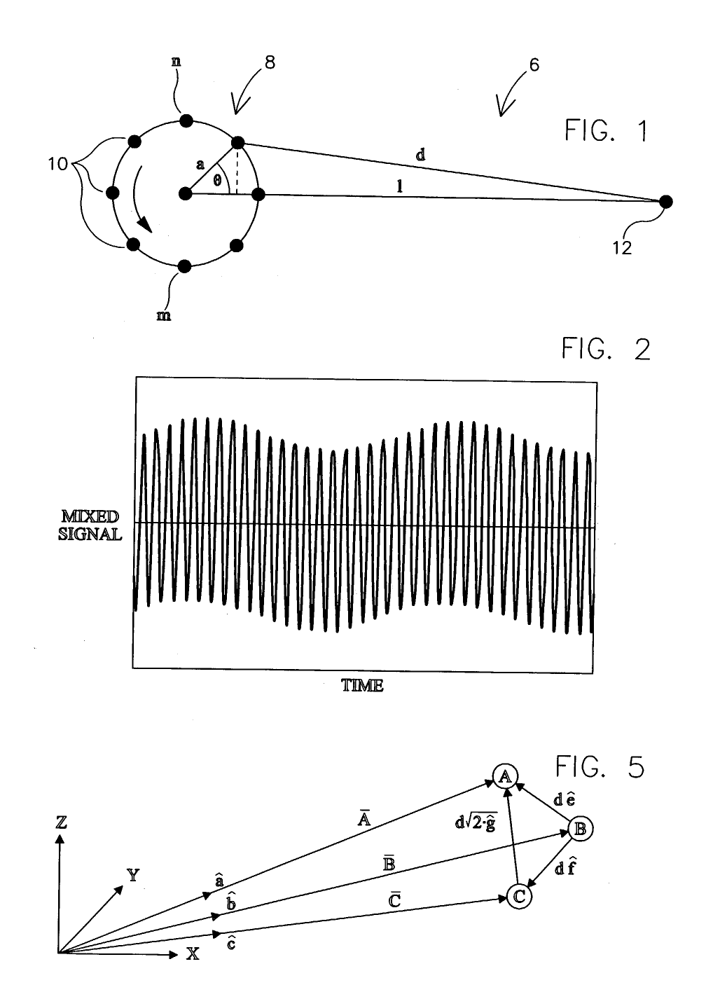

The receiving antenna 12 receives a signal that is the composite of all of the signals transmitted by the transmitting antennae 10. The concept of a Doppler field transmitter can be illustrated by superimposing the composite signal and base signal, also referred to as “mixing.” A mixed signal displays both the high frequency and low frequency differences between the composite and the base transmitted signals. FIG. 2 illustrates the mixed signal obtained by superimposing the composite signal detected by the receiving antenna 12 and the base transmitted signal. The low frequency component of the mixed signal results from the Doppler shift. The frequency of the low frequency component matches the orbiting rate of the virtual antenna. The high frequency component of the mixed signal corresponds to the base transmitted signal.

A virtual antenna generates a Doppler field. A single receiving antenna 12 can detect the oscillations in frequency caused by the Doppler field. Each cycle of the change in frequency is a result of one revolution of the virtual antenna around its orbital path. The highest value, or peak in frequency, corresponds to the maximum velocity of approach between the virtual antenna and the receiving antenna. With reference to FIG. 1, the maximum and minimum Doppler shift are located at points m and n, respectively, where the velocity of approach and departure are at their corresponding maxima. Whether point m or n is a maximum or a minimum depends on the direction of travel of the virtual antenna (i.e., clockwise or counterclockwise). Thus, the zero crossings, or nulls, of the Doppler shift are located on a line extending from the center of the virtual antenna 8 and the receiving antenna 12. No matter where the receiving antenna 12 is located in the plane around the Doppler field transmitter, the line defined by the zero crossings, or nulls, points directly to the receiving antenna.

The use of a synchronizing pulse during a predetermined position in the orbit of the virtual antenna can be used to measure the angle to the receiving antenna 12 in the plane defined by the orbit of the virtual antenna 8. The time lapse between the synchronizing pulse and the zero crossings of the Doppler shift is directly proportional to the angular position of the receiving antenna 12 in a plane. The angular position of the receiving antenna 12 can be determined from the following formula:

θ=2π·f_{Doppler}·Δₜᵢₘₑ (3)

where f_{Doppler} is the Doppler rotation frequency of the virtual antenna and Δₜᵢₘₑ is the time lapse between the synchronization pulse and the zero crossing. The two-dimensional (2D) angular measurement is the basis of the three-dimensional (3D) position determination of the invention.

The motion capture system 6 illustrated in FIG. 1 and discussed above can accurately measure the angular position of the receiving antenna 12. For example, in a Doppler field transmitter comprising a virtual antenna 8 orbiting at the rate of 5000 Hz and a standard 1 GHz counter, each time interval corresponds to +/−0.0018° (5000 cycles/second×10⁻⁹ seconds×360°/cycle=0.0018°). With this arrangement, the position of a receiving antenna 12 at a distance of 20 meters from the transmitting antennae could be accurately measured to +/−0.6 millimeters (20×10³ millimeters×tan (0.0018°)=0.6 millimeters).

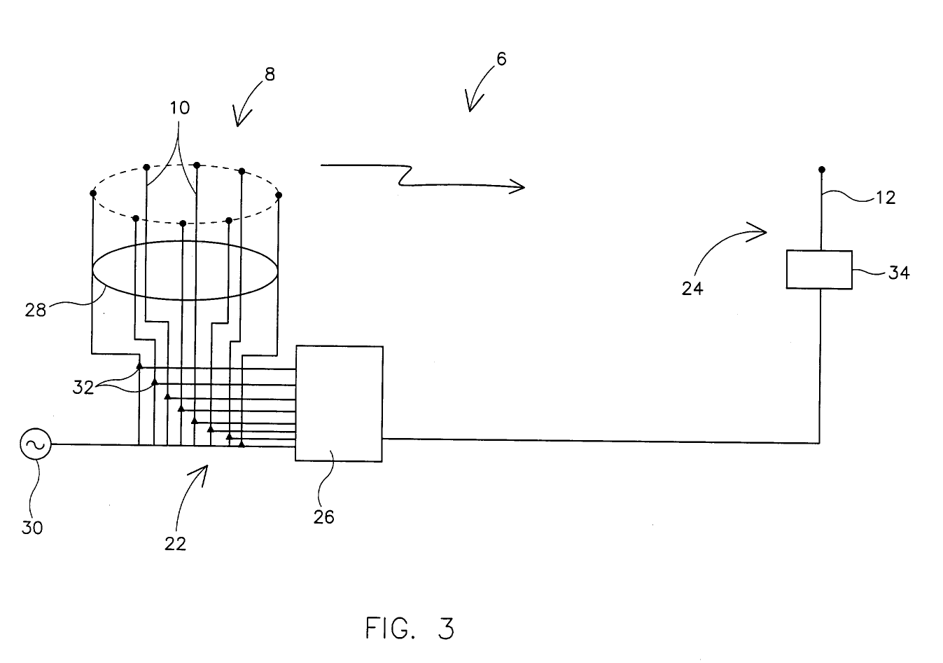

Referring now to the drawings and in particular to FIG. 3, a system for determining and tracking the position of a movable object in two-dimensions is designated in its entirety by the reference numeral 6. The system 6 comprises a transmitter 22 for transmitting a periodic orbiting EM signal, a sensor 24 mountable on an object (not shown) for receiving the signal transmitted by the transmitter, and a controller 26 in communication with the transmitter 22 and the sensor 24 for determining the position of the sensor relative to the transmitter. Accordingly, the controller 26 determines and tracks the position of the object upon which the sensor 24 is mounted relative to the transmitter 22.

In one embodiment shown in FIG. 3, the transmitter 22 comprises a virtual transmitter antenna 8. The virtual transmitter antenna 8 includes an antenna array 28 having a plurality of antennae 10 transmitting an orbiting periodic EM signal. The orbiting periodic EM signal has a generally constant predetermined nominal wavelength. The array 28 generally has at least three antennae 10. Preferably, the array has eight or more antennae 10. The EM signal transmitted by each of the antennae 10 in the array has the same predetermined nominal frequency but is phase shifted so the EM signals of all of the antennae 10 constructively interfere to create a composite EM signal at the sensor 24. Preferably, the amplitude of the EM signal transmitted by each antenna 10 is identical although the instantaneous power levels of the antennae vary due to the phase shift.

The antenna array 28 may have a variety of configurations, but preferably has a circular configuration. Although the size of the circular configuration of the array may vary without departing from the scope of the present invention, in one embodiment the array 28 has a radius equal to a fraction or multiple of the nominal wavelength of the orbiting periodic EM signal. More preferably, the antenna array 28 has a radius equal to about one-fourth of the nominal wavelength of the orbiting periodic EM signal. In one embodiment, the radius of the circular configuration is about 8 centimeters. For convenience, the antennae 10 are equal-spaced around the circumference of a circular array.

Each antenna 10 may have varying lengths, but preferably has a length equal to a fraction or multiple of the nominal wavelength of the orbiting periodic EM signal. More preferably, each antenna has a length equal to about one-fourth of the nominal wavelength of the orbiting periodic EM signal. More preferably still, each antenna has a length equal to about 8 centimeters. For example, a CW Series antenna manufactured by Linx Technologies, Inc. of Grants Pass, Oreg., may be used. Each antenna 10 is connected to a transceiver 30 operating in transmit mode, preferably generating a radio frequency signal. One such transceiver is a SC Series transceiver available from Linx Technologies, Inc. operating at about 916 MHz. The transceiver 30 and each antenna 10 are connected to amplifiers 32 to increase the power of the signals transmitted by the antennae. In one embodiment, BBA Series amplifiers available from Linx Technologies are used. The transmitter 22 is capable of generating a periodic orbiting EM signal with an orbiting rate of several thousand Hertz (e.g., 5000 Hz).

In another embodiment (not shown), the transmitter comprises an orbiting transmitter antenna that transmits a periodic EM signal. The antenna is rotated in an orbital path by a mechanical device at a rate sufficient to create a detectable Doppler shift in the frequency of the transmitted EM signal (e.g., 100,000 rpm).

The sensor 24, which receives the signal transmitted by the transmitter, comprises a receiver 34 in communication with a receiver antenna 12. In one embodiment, the receiver 34 is a transceiver operating in receive mode. The transceiver such as, for example, a SC Series, transceiver available from Linx Technologies, Inc., operating at about 916 MHz demodulates the composite signal and sends an audio level zero crossing indicator or signal to the controller 26.

The receiver antenna 12 may have various lengths, but preferably has a length equal to a fraction or multiple of the nominal wavelength of the orbiting periodic EM signal. More preferable, the receiver antenna has a length equal to about one-fourth of the nominal wavelength of the orbiting periodic EM signal. In one embodiment, the length of the receiver antenna is equal to about 8 centimeters. One such antenna is a CW Series antenna available from Linx Technologies, Inc.

The controller 26 preferably comprises a digital signal processor such as, for example, a model TMS320C28x processor available from Texas Instruments Incorporated of Dallas, Tex. The controller 26 communicates with the transmitter 22 and controls the timing of the antenna power cycling by regulating the appropriate control voltage supplied to each of the amplifiers 32. Additionally, the controller 26 receives the audio level signal from the sensor 24 and calculates the zero crossing of the Doppler signal detected at the sensor. The zero crossing is a line extending from the center of the virtual antenna 6 (FIG. 1) and the receiving antenna 12. The zero crossing defines the angular position of the sensor 24 in the orbital plane relative to the transmitter 22. After the determination of the initial angular position of the sensor 24, the controller 26 calculates changes in the zero crossing of the Doppler signal to determine changes in the angular position of the sensor over time.

The distance between the transmitter 22 and the sensor 24 can be determined, for example, by measuring the root-mean-square signal strength at the sensor and comparing it with that at the transmitter. Because EM signal strength decreases as an inverse function of the square of the distance between the transmitter 22 and the receiver 24, measuring signal strength will yield the distance between the transmitter and sensor through a straightforward calculation.

The distance can also be determined by using two transmitters. Because each transmitter 22 defines a zero crossing line, the intersection of those lines yields a unique position for the sensor 24.

In the embodiment shown in FIG. 3, the controller 26 is hard-wired to the transmitter 22 and the sensor 24. The controller 26 may be connected to a personal computer or another device (not shown) that can collect, store and display the angle calculations obtained from the controller.

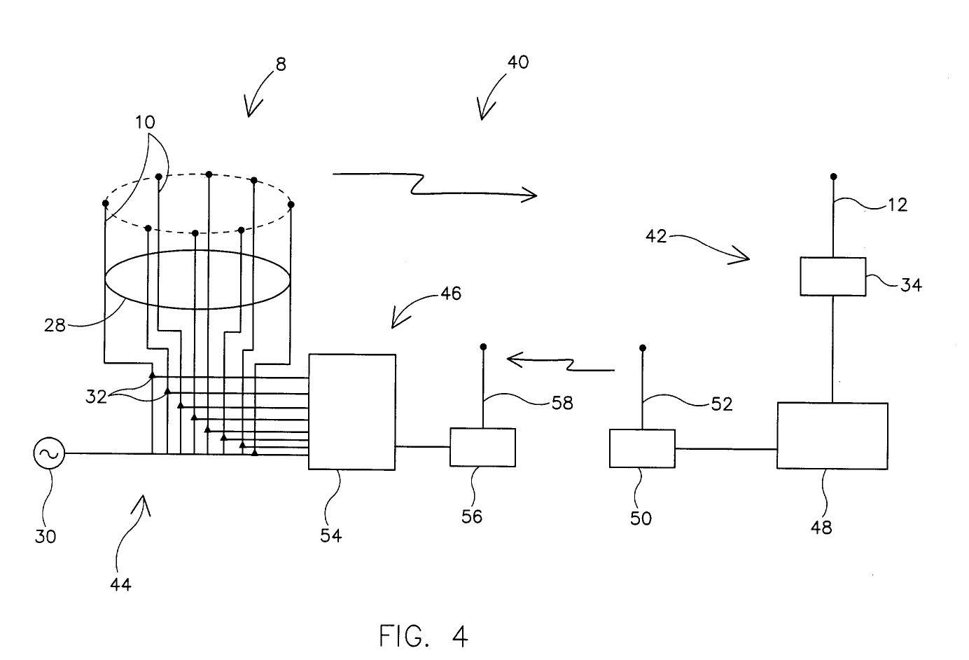

FIG. 4 shows a system 40 for determining the position of an object in two-dimensions using a wireless sensor 42. The system 40 comprises a transmitter 44 for transmitting a periodic orbiting EM signal, a sensor 42 mountable on an object for receiving the signal transmitted by the transmitter, and a controller 46 in communication with the transmitter and the sensor for determining the position of the sensor relative to the transmitter thereby determining the position of the object upon which the sensor is mounted relative to the transmitter.

In the embodiment shown in FIG. 4, the sensor 42 comprises a receiver 34 in communication with a receiver antenna 12 for receiving the signal transmitted by the transmitter 44. The receiver 34 comprises a transceiver operating in receive mode. The transceiver such as, for example, a SC Series transceiver available from Linx Technologies, Inc. operating at about 916 MHz, demodulates the composite signal and sends the audio level zero crossing signal to a remote signal processor 48.

The remote signal processor 48 such as, for example, a model TMS320C28x processor available from Texas Instruments Incorporated, is disposed in communication with the receiver 34 for receiving and analyzing the audio level zero crossing signal for digital timing information, and routing the signal to the telemetry transmitter 50.

In one embodiment, the telemetry transmitter 50 comprises a transceiver such as, for example, a Linx Technologies, MC Series transmitter available from Linx Technologies, Inc. operating in transmit mode at about 916 MHz. The telemetry transmitter 50 communicates with the remote signal processor 48 and further comprises an antenna 52 for transmitting telemetry data to the controller 46. Alternatively, because the receiver 34 and the telemetry transmitter 50 each operate on an isolated radio carrier frequency, they may be configured to share the receiver antenna 12 in order to receive signals and transmit telemetry data.

In the embodiment shown in FIG. 4, the controller 46 comprises a main signal processor 54 that is preferably a digital signal processor such as, for example, a model TMS320C28x available from Texas Instruments Incorporated. The controller 46 communicates with the transmitter 44 and controls the timing of the antenna power cycling by regulating the appropriate control voltage to each of the amplifiers 32. The controller 46 also generates and controls the timing of a synchronization pulse transmitted by the transmitter 44. The synchronization pulse is emitted during each orbit of the virtual antenna when the orbiting EM signal is in a predetermined angular position in the orbital plane.

The main signal processor 54 is operatively connected to a telemetry receiver 56 having a telemetry antenna 58 for receiving telemetry data from the telemetry transmitter 50. The telemetry receiver 56 is preferably a transceiver such as, for example, an MC Series transceiver available from Linx Technologies, Inc. operating in receive mode at about 916 MHz.

The receiver antenna 36, the antenna 52 and the telemetry antenna 58 may have various lengths, but preferably each has a length equal to a fraction or multiple of the nominal wavelength of the orbiting periodic EM signal. More preferably, each antenna 36, 52, 58 has a length equal to about one-fourth of the nominal wavelength of the orbiting periodic EM signal. In one embodiment, the receiver antenna 36, the antenna 52 and the telemetry antenna 58 each have a length equal to about 8 centimeters. For example, a CW Series antenna available from Linx Technologies, Inc. may be used for these purposes.

The controller 46 calculates the time difference between the synchronization pulse and the zero crossing of the Doppler signal detected at the sensor 42 to determine the angular position of the sensor in the orbital plane relative to the transmitter 44. After the determination of the initial angular position of the sensor, the controller calculates changes in the zero crossing of the Doppler signal to determine changes in the angular position of the sensor over time. The controller 46 may be connected to a personal computer or another device (not shown) that can collect, store and display the angle calculations obtained from the controller.

The distance between the transmitter and the sensor can be determined as previously described.

The concepts of the motion capture system illustrated in FIG. 1 can be extended to measuring the position of an object in 3D. The determination of the 3D position of a receiver involves the use of three receiving antennae (sensor triad) and the addition of a virtual antenna with an orbital path in an additional plane. For purposes of convenience, the second orbital path is in a plane orthogonal to the plane of orbit of the virtual antenna in FIG. 1.

FIG. 5 illustrates the vector notation that mathematically describes the three-dimensional position of receiving antennae A, B and C of a sensor triad that can be attached to an object to determine its position. Unit vectors â, \hat{b} and ĉ represent the angular position information obtained from two virtual antennae orbiting in orthogonal planes. These vectors point to the locations of each of the receiving antennae A, B, C of the sensor triad but contain no information about distance or range. The distance and 3D position vector for each receiving antenna are calculated from the information provided. In FIG. 5, vectors [symbol] , [symbol] and [symbol] represent the 3D position of each of the receiving antennae where the unit vectors ê, \hat{f} and ĝ provide information about the orientation of the sensor triad. In FIG. 5, the value d is the distance between the receiving antennae on the sensor triad. FIG. 5 forms the basis for the equations used to calculate the sensor triad position and orientation in 3D space. Equations 4, 5, 6 and 7, illustrate the relationships between the variables shown in FIG. 5.

[symbol]

=A·â, [symbol] =B·\hat{b}, [symbol] =C·ĉ (4)

[symbol]

− [symbol] =A·â−B·\hat{b}=d·ê (5)

[symbol]

− [symbol] =C·ĉ−B·\hat{b}=d·\hat{f} (6)

[symbol]

− [symbol] −A·\overline{a}−C·ĉ=d·\sqrt{2·ĝ} (7)

The known variables in the previous equations are the unit vectors â, \hat{b} and ĉ, as well as the distances between each of the receiving antennae, variable d. The unknown variables are variables A, B and C, as well as unit vectors ê, \hat{f} and ĝ. However, a relationship between ê, \hat{f} and ĝ exists and is described in Equation 8.

d·\sqrt{2·ĝ}=d··(ê−\hat{f}) (8)

This relationship can be combined with Equation 7 to form Equation 9.

[symbol]

− [symbol] =A·â−C·ĉ=d·(ê−\hat{f}) (9)

The substitution reduces the field of unknown variables to nine. (Each unit vector represents three unique parameters in 3D measurements, so two unit vectors (6 unknowns) and 3 magnitudes produces a total of nine unknowns.) In order to find a unique solution, a total of nine independent equations must also be defined. Expanding Equations 5, 6 and 9 into x, y and z components yields the required nine equations. Solving this set of linear equations yields both the position and orientation of the receiving antennae on the sensor triad.

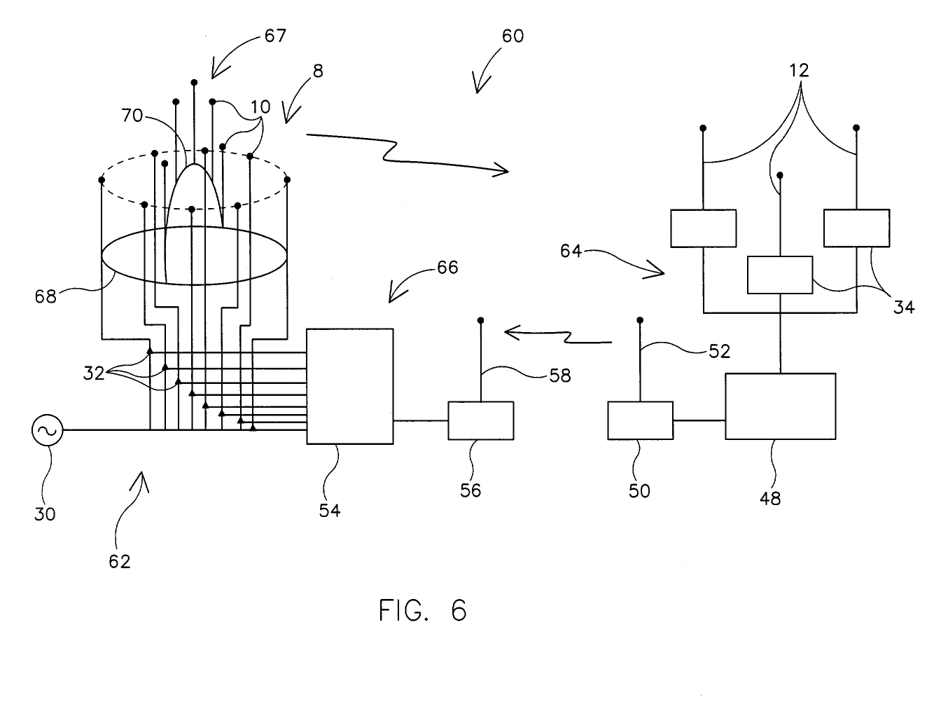

FIG. 6 shows a system 60 for determining the position and orientation of a moving object in three dimensions. The system comprises a transmitter 62 for transmitting two periodic orbiting EM signals, a sensor 64 mountable on an object for receiving the signals transmitted by the transmitter 62, and a controller 66 in communication with the transmitter and the sensor for determining the position of the sensor relative to the transmitter thereby determining the position of the object upon which the sensor is mounted relative to the transmitter.

The transmitter 62 comprises a first virtual transmitter antenna 8 for transmitting a first periodic orbiting EM signal in a first plane, and a second virtual transmitter antenna, generally designated by 67, for transmitting a second periodic orbiting EM signal in a second plane. The first and second transmitter antennae 8, 67, respectively, may comprise a first antenna array 68 and a second antenna array 70 each including a plurality of antennae 10 transmitting orbiting and/or traveling periodic EM signals in first and second planes, respectively. Each of the first and second antenna arrays 68, 70 generally has at least four antennae 10, and preferably has eight and five antennae 10, respectively. The EM signal transmitted by each of the antennae 10 in each of the first and second antenna arrays has a generally constant predetermined frequency and a generally uniform wavelength but is phase shifted so the EM signals of all the antennae 10 constructively interfere to create composite EM signals at the sensor 64. The power level of the EM signal transmitted by each antenna 10 is varied cyclically, creating composite EM signals orbiting in the first and second planes, respectively.

The first antenna array 68 may have a variety of configurations, but preferably has a circular configuration. The second antenna array 70 is preferably configured in the form of a semi-circle thus creating a second cyclically traveling EM signal with a semi-circular path. Preferably, the circular and semi-circular configurations of the first and second antenna arrays 68, 70 have a common center such that the first and second orbiting EM signals transmitted by the transmitter 62 have a common orbital center. Preferably, the first and second planes are orthogonal to each other as shown in FIG. 6.

The sizes of the circular configuration of the first antenna array 68 and the semi-circular configuration of the second antenna array 70 may vary, but preferably each has a radius equal to a fraction of the nominal wavelength of the orbiting periodic EM signals. More preferably, the first and second antenna arrays 68, 70 each have a radius equal to about one-forth of the nominal wavelength of the orbiting periodic EM signals. In one embodiment, the first and second antenna arrays 68, 70 each have a radius of about 8 centimeters. Although the antennae 10 may have other spacings without departing from the scope of the present invention, in one embodiment, the antennae 10 are equally spaced around the first and second antenna arrays.

Each antenna 10 may have varying lengths, but preferably their length is equal to a fraction or multiple of the nominal wavelength of the orbiting periodic EM signals. More preferably, each antenna 10 has a length equal to about one-fourth of the nominal wavelength of the orbiting periodic EM signals. In one embodiment, each antenna has a length equal to about 8 centimeters. One such antenna is a CW Series antenna available from Linx Technologies, Inc.

Each antenna 10 is connected to a transceiver 30 operating in transmit mode, preferably generating a radio frequency signal. A SC Series transceiver available from Linx Technologies, Inc. operating at about 916 MHz may be used to generate a radio frequency signal.

The transceiver 30 and each antenna 10 are connected to amplifiers 32 to increase the power of the signals transmitted by the antennae. BBA Series amplifiers available from Linx Technologies, Inc. may be used.

The sensor 64 comprises a plurality of receivers 34, each in communication with a receiver antenna 36 fixedly mounted on a rigid base. Preferably the sensor 64 comprises three receivers 34 fixedly mounted on a rigid base and arranged at a predetermined and known distance from one another. Typical machine shop production methods are capable of fixedly mounting the receivers 34 to the rigid base within a tolerance of about 0.0254 millimeters (0.001 inches).

Each of the receivers 34 comprises a transceiver, such as, for example, a SC Series transceiver available from Linx Technologies, Inc. operating at about 916 MHz in receive mode. Each of the receivers 34 demodulates the composite signals and sends audio level zero crossing signals to the remote signal processor 48. Because each receiver antenna 36 is located at a different distance and angular position relative the transmitter 62, it will receive unique zero crossing information from the first and second periodic EM signals.

The remote signal processor 48 such as a model TMS320C28x processor available from Texas Instruments Incorporated is disposed in communication with each of the receivers 34 for receiving and analyzing the audio level zero crossing signal for digital timing information, and routing the signals to the telemetry transmitter 50.

The telemetry transmitter 50 comprises a transceiver such as an MC Series transceiver available from Linx Technologies, Inc. operating at about 916 MHz in transmit mode. The telemetry transmitter is in communication with the remote signal processor 48 and further comprises an antenna 52 for transmitting telemetry data to the controller 66. Alternatively, because each of the receivers 34 and the telemetry transmitter 50 operate on an isolated radio carrier frequency, they may be configured to share the receiver antenna 36 in order to receive signals and transmit telemetry data.

In the embodiment shown in FIG. 6, the controller 66 comprises a main signal processor 54 that is preferably a digital signal processor such as a model TMS320C28x processor available from Texas Instruments Incorporated. The controller 66 is in communication with the transmitter 62 and controls the timing of the antenna power cycling by regulating the appropriate control voltage to each of the amplifiers 32. The controller 66 also generates and controls the timing of first and second synchronization pulses transmitted by the transmitter 62. The first and second synchronization pulses are emitted at the same predetermined time during each cycle of the first and second periodic EM signals, respectively, when they are in a predetermined angular position in their respective planes.

The main signal processor 54 is operatively connected to a telemetry receiver 56 having a telemetry antenna 58 for receiving telemetry data from the telemetry transmitter 50. The telemetry receiver 56 is preferably a transceiver such as an MC Series transceiver available from Linx Technologies-, Inc. operating at about 916 MHz in transmit mode.

The receiver antennae 36, the antenna 52 and the telemetry antenna 58 may have various lengths, but preferably each has a length equal to a fraction or multiple of the nominal wavelength of the periodic EM signals. More preferably, each of such antennae has a length equal to about one-fourth of the nominal wavelength of the periodic EM signals. In one embodiment, each of such antennae has a length equal to about 8 centimeters. A CW Series antenna available from Linx Technologies, Inc. may be used for these purposes.

The controller 66 calculates the time difference between the first and second synchronization pulses and the zero crossings of the Doppler signal detected at the sensor 64 according to Equation 3 above to determine the angular position of the each of the receiver antennae 36 relative to the transmitter 62. The controller then computes three-dimensional position and orientation of each of the receiver antennae 36 in accordance with the Equation 10:

[K]·{U}={0} (10)

Equation 10 is the matrix formulation of a nine-equation simultaneous solution described above. Matrix K is composed of the known constants and Matrix U is composed of the unknown variables.

After the determination of the initial angular position of the sensor, the controller 66 calculates changes in the zero crossings of the Doppler signals to determine changes in the angular position and orientation of the sensor over time. The controller 66 may be connected to a personal computer or another device (not shown) that can collect, store and display the angle calculations obtained from the controller.

In view of the above, it will be seen that the several objects of the invention are achieved and other advantageous results attained. For example, each of the described embodiments can be adapted to determine and track the position of multiple sensors. Also it is readily apparent that the principles of the invention can be used for a variety of systems that generate a unique environment or field in which one or more sensors detect their own position and orientation. Thus, for example, an audible speaker can be used to provide a sound field and the sensor can consist of a microphone. The data from each microphone sensor can be compared to the synchronized source to determine the position and orientation of the sensor.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description, or shown in the accompanying drawings, shall be interpreted as illustrative and not in a limiting sense.

1. An apparatus for determining and tracking a position of at least one movable object, said apparatus comprising:
a transmitter having a transmitter antenna for transmitting a periodic electromagnetic signal;
a sensor mountable on the object including a receiver having a receiver antenna for receiving the signal transmitted by the transmitter; and
a controller connected to said transmitter and in communication with said sensor for controlling said periodic electromagnetic signal and for determining the position of the sensor relative to said transmitter thereby determining the position of the object upon which said sensor is mounted relative to said transmitter.

2. An apparatus as set forth in claim 1 wherein said signal has a generally constant predetermined nominal wavelength and said transmitter antenna has a length equal to a fraction of said signal wavelength.

3. An apparatus as set forth in claim 2 wherein said transmitter antenna length is about one-fourth of said signal wavelength.

4. An apparatus as set forth in claim 2 wherein said signal wavelength is about thirty-two centimeters.

5. An apparatus as set forth in claim 1 wherein said transmitter antenna has a length equal to about eight centimeters.

6. An apparatus as set forth in claim 1 wherein said signal has a generally constant predetermined nominal wavelength and said transmitter antenna has a length equal to a multiple of said signal wavelength.

7. An apparatus as set forth in claim 1 wherein said signal has a generally constant predetermined nominal wavelength and said receiver antenna has a length equal to a fraction of said signal wavelength.

8. An apparatus as set forth in claim 7 wherein said receiver antenna length is about one-fourth of said signal wavelength.

9. An apparatus as set forth in claim 7 wherein said signal wavelength is about thirty-two centimeters.

10. An apparatus as set forth in claim 1 wherein said receiver antenna has a length of about eight centimeters.

11. An apparatus as set forth in claim 1 wherein said signal has a generally constant predetermined nominal wavelength and said receiver antenna has a length equal to a multiple of said signal wavelength.

12. An apparatus as set forth in claim 1 wherein:
the sensor includes a remote signal processor in communication with the sensor receiver and a telemetry transmitter in communication with the remote signal processor for sending telemetry data generated by the remote signal processor to the controller; and
the controller includes a telemetry receiver having a telemetry antenna for receiving the telemetry data from the telemetry transmitter, and a main signal processor operatively connected to the telemetry receiver for analyzing the telemetry data.

13. An apparatus as set forth in claim 12 wherein:
the electromagnetic signal produced by the transmitter antenna orbits in an orbital plane about an orbital center and includes a synchronization pulse transmitted when the signal is in a predetermined angular position measured in the orbital plane from the orbital center; and
the controller is adapted to determine an angular relation between the sensor measured in the orbital plane and the position of the signal during the synchronization pulse.

14. An apparatus for determining and tracking a position of a moving object, said apparatus comprising:
a transmitter having an antenna array including a plurality of antennae, each of said antennae transmitting an electromagnetic signal having a periodically varying amplitude varying at a predetermined frequency equal to that of the signals transmitted by the other antennae within the array, the signal transmitted by each of said antennae being phase shifted relative to the signal transmitted by the adjacent antennae so the signals transmitted by the antenna array form a traveling composite electromagnetic signal;
a sensor mountable on the object including a receiver having a receiver antenna for receiving the composite signal transmitted by the antenna array; and
a controller in communication with said transmitter and said receiver for determining the position of the sensor relative to said transmitter thereby determining the position of the object upon which said sensor is mounted relative to said transmitter.

15. An apparatus as set forth in claim 14 wherein said frequency at which the signal amplitude varies is about 1 gigahertz.

16. An apparatus as set forth in claim 14 wherein said plurality of antennae in the array are arranged in a generally circular pattern having a predetermined radius.

17. An apparatus as set forth in claim 16 wherein said plurality of antennae are equally spaced.

18. An apparatus as set forth in claim 17 wherein said composite signal has a generally constant predetermined nominal wavelength and said radius is a fraction of said wavelength.

19. An apparatus as set forth in claim 18 wherein said radius is about one-fourth of said wavelength.

20. An apparatus as set forth in claim 17 wherein said signal further has a generally constant predetermined nominal wavelength and said radius is a multiple of said wavelength.

21. An apparatus as set forth in claim 17 wherein said radius has a length of about eight centimeters.

22. An apparatus for determining and tracking a position of a moving object, said apparatus comprising:
a transmitter having a first transmitter antenna for transmitting a first periodic electromagnetic signal in a first plane, and a second transmitter antenna for transmitting a second periodic electromagnetic signal in a second plane;
a sensor mountable on the object including a receiver having a receiver antenna for receiving said signals transmitted by the transmitter; and
a controller in communication with said transmitter and said sensor for controlling said first and second periodic electromagnetic signals and for determining the position of the sensor relative to said transmitter thereby determining the position of the object upon which said sensor is mounted relative to said transmitter.

23. An apparatus as set forth in claim 22 wherein:
the sensor further comprises a remote signal processor in communication with the sensor receiver and a telemetry transmitter in communication with the remote signal processor for sending telemetry data generated by the remote signal processor to the controller; and
the controller further comprises a telemetry receiver having a telemetry antenna for receiving the telemetry data from the telemetry transmitter, and a main signal processor operatively connected to the telemetry receiver for analyzing the telemetry data.

24. An apparatus as set forth in claim 22 wherein said first electromagnetic signal and said second electromagnetic signal have a common orbital center.

25. An apparatus as set forth in claim 23 wherein:
said first electromagnetic signal comprises a synchronization pulse transmitted when said first signal is in a predetermined angular position measured in said first plane;
said second electromagnetic signal comprises a synchronization pulse transmitted when said second signal is in a predetermined angular position measured in said second plane; and
the controller is adapted for determining a first angular relation between the sensor measured in said first plane and the position of said first signal during the synchronization pulse and a second angular relation between the sensor measured in said second plane and the position of said second signal during the synchronization pulse.

26. An apparatus as set forth in claim 22 wherein said first plane is generally orthogonal to said second plane.

27. An apparatus as set forth in claim 22 wherein said transmitter antennae are capable of producing signals that orbit 360 degrees.

28. An apparatus as set forth in claim 22 wherein said first transmitter antenna is capable of producing a signal that orbits 360 degrees and said second transmitter antenna in capable of producing a signal that travels 180 degrees.

29. A method for determining the position of at least one moving object relative a transmitter connected to a controller, said method comprising the steps of:
transmitting at least one periodic traveling electromagnetic signal;
detecting said signal with a sensor mountable on the object;
converting the signal into a Doppler shift zero crossing indicator;
determining from said indicator the position of the sensor relative to said transmitter thereby determining the position of the object upon which said sensor is mounted relative to said transmitter.

30. A method as set forth in claim 29 further comprising:
transmitting at least one synchronization pulse when said periodic electromagnetic signal is in a predetermined angular position; and
determining an angular position between the sensor and the position of said signal during the synchronization pulse.

31. An apparatus as set forth in claim 22 wherein said sensor includes a plurality of receivers and wherein said controller is capable of determining an orientation of the sensor relative to said transmitter thereby determining the orientation of the object upon which said sensor is mounted relative to said transmitter.

32. A method as set forth in claim 29 wherein said sensor includes a plurality of receivers, said method further comprising:
determining from said indicator the orientation of the sensor relative to said transmitter thereby determining an orientation of the object upon which said sensor is mounted relative to said transmitter.
